(19) United States
(12) Patent Application Publication
(10) Pub. No.: US 2009/0057238 A1
(43) Pub. Date: Mar. 5, 2009

(54) Pool cleaning robot

(76) Inventor: Efraim Garti, Zirchon Yaakov (IL)

Correspondence Address: THE NATH LAW GROUP, 112 South West Street, Alexandria, VA, 22314, US

(21) Appl. No.: 11/896,611

(22) Filed: Sep. 4, 2007

(51) Int. Cl. B01D 21/30; B01D 35/02; C02F 1/00; G01C 21/20

(52) U.S. Cl. 210/739; 210/143; 210/91; 73/178 R; 901/1

(57) ABSTRACT

A pool cleaning robot adapted to move in a direction along the bottom surface of a pool. The robot comprises a compass, a rate gyroscope, and a controller adapted to determine the orientation of the robot, relative to a reference orientation thereof, based on readings of the compass and the gyroscope.

### FIELD OF THE INVENTION

This invention relates to devices and methods for cleaning swimming pools, basins, and the like. More particularly, the invention relates to an automatic self-propelled cleaning robot.

### BACKGROUND OF THE INVENTION

Pool cleaning robots, that is, robot-like devices which automatically scan along, typically, at least the bottom surface of a pool or other similar liquid-filled basin, are known in the art. Typically, a pool cleaning robot comprises locomotion means, such as wheels or track-belts, an inlet, and outlet, and suction means to move water into the body of the robot via the inlet and expel it via the outlet, and a filter to clean the water as it passes through the body of the robot between the inlet and the outlet. The robots may be corded or cordless, i.e., battery powered.

In addition, the robot may comprise a robot controller adapted to direct the motion of the robot according to one or more preprogrammed algorithms. During normal operation, the motion normally includes a straight path which the robot would ideally follow as part of the algorithm. However, due to a number of conditions, including, but not limited to, shifting of the robots due to movement of the water, slippage of the drive belts along the floor, bumps and/or depressions in the floor of the pool, etc., this ideal straight path is often not realized by the robot. Therefore, if the robot would scan according to a scanning algorithm which depends on the robot following a straight path, chances are high that the robot would scan erroneously, and the accumulated error may result in a noticeable deviation from the intended scanning path.

Before the initial use of the robot, it usually undergoes a setup procedure based on parameters of the pool, such as the dimensions of the pool, its general orientation (i.e., in which compass direction it is oriented), etc. In addition, the length of time of a scanning cycle may be provided by the user.

### SUMMARY OF THE INVENTION

According to one aspect of the present invention, there is provided a pool cleaning robot adapted to move in a direction along the bottom surface of a pool, the robot comprising a compass (which may be a digital compass), a rate gyroscope (which may be a Micro-Electro-Mechanical System rate gyroscope), and a controller adapted to determine the orientation of the robot, relative to a reference orientation thereof, based on readings of the compass and the gyroscope.

The controller may be adapted to calculate the average compass reading over a predetermined period of time, compare the average to the gyroscope reading over the predetermined period, and compensate the reading of the rate gyroscope based on the comparison.

The robot may further comprise at least one tilt sensor, the controller being adapted to selectively determine, based on the reading of the at least one tilt sensor, the location of the robot based on the readings of the compass alone or based on the readings of the compass and the rate gyroscope.

The robot may further comprise a temperature sensor, the controller being adapted to compensate for reading of the rate gyroscope based on the reading of the temperature sensor.

The pool may be rectangular, in which case the reference orientation is one of the length and width of the pool.

According to another aspect of the present invention, there is provided a method of determining the orientation of a pool cleaning robot relative to a reference location, the robot comprising a compass (which may be a digital compass), a rate gyroscope (which may be a Micro-Electro-Mechanical System rate gyroscope), and a controller adapted to determine the orientation, the method comprising determining the orientation based on readings of the compass and the gyroscope.

The controller may be adapted to calculate the average compass reading over a predetermined period of time, compare the average to the gyroscope reading over the predetermined period, and compensate the reading of the rate gyroscope based on the comparison.

The robot may further comprise at least one tilt sensor, the controller being adapted to selectively determine, based on the reading of the at least one tilt sensor, the location of the robot based on the readings of the compass alone or based on the readings of the compass and the rate gyroscope.

The robot may further comprise a temperature sensor, the controller being adapted to compensate for reading of the rate gyroscope based on the reading of the temperature sensor.

The pool may be rectangular, in which case the reference orientation is one of the length and width of the pool.

According to a further aspect of the present invention, there is provided a setup system for a pool cleaning system, the pool cleaning system comprising a pool cleaning robot and a control system, the control system comprising a first controller adapted to direct the operation of the robot based on predetermined setup parameters, a second controller, and a user interface having at least one input/output mechanism; the second controller being adapted to:
(a) communicate with the first controller to provide the setup parameters thereto;
(b) issue commands to the first controller to direct the operation of the robot; and
(c) prompt a user, via the user interface, to perform an operation and/or to provide information, based on which at least some of the operational parameters are determined.

At least one of the setup parameters may be selected from the group comprising one or more of dimensions of the pool, cycle time, delay until cycle start, scanning method, whether to log scanning data, and pool shape.

The control system may be adapted to store multiple sets of setup parameters for multiple pools, to store scanning data, and/or to store the scanning information on removable media.

The user interface may further comprise a remote control adapted to communicate with the first controller to provide instructions, e.g., relating to the orientation of the robot, regarding directing the robot.

The user interface may be adapted to display information regarding the status of the robot. The information may relate to one or more of the filter status, alert status, pool information, and cycle status.

According to a still further aspect of the present invention, there is provided a setup system for a pool cleaning robot adapted to move in a direction along the bottom surface of a substantially rectangular pool, the robot comprising a controller and digital compass in communication with the controller; the controller being adapted to direct the operation of the robot based on geometric parameters of the pool, the setup system being adapted to communicate with the controller to direct the robot to perform the following operations to determine at least some of the parameters:
(a) aligning the robot such that its direction of travel is perpendicular to a sidewall of the pool;
(b) scanning along a straight trajectory for a first predetermined time;
(c) calculating the average trajectory measured by the digital compass of the robot during the first predetermined time; and
(d) determining at least some of said parameters based on the average trajectory.

The setup system may be further adapted to receive user input based on which the controller performs the alignment.

According to a still further aspect of the present invention, there is provided a method for cleaning a bottom surface of a pool, the method comprising the steps of providing a pool cleaning robot comprising a controller adapted to direct its operation, the controller directing operation of the robot such that:
(a) the robot scans in a first scanning direction until a front detection occurs;
(b) after the front detection, the robot reverses direction and performs a straight lap along a path which is shifted, in a first shifting direction perpendicular to that of the first scanning direction, from the previous path;
(c) the robot repeats step (b) for a predetermined number of times;
(d) subsequently, the robot performs a stepped lap, and after the 90° rotation thereof, scans in a second shifting direction which is opposite the first shifting direction for a distance equal to twice the total amount shifted during step (c);
(e) subsequently, the robot rotates 90°, and scans until a front detection occurs;
(f) steps (b) through (d) are repeated until a front detection occurs during step (d);
(g) subsequently, the robot reverses direction and scans for a distance equal to the total amount shifted during one iteration of step (c), then rotates 90° and scans until a front detection occurs; and
(h) subsequently, the robot repeats steps (b) through (f), with the directions of the first and second shifting directions being reversed.

The controller may further direct operation of the robot such that:
(i) subsequently, the robot performs a stepped lap, and performs a straight lap; and
(j) the robot repeats steps (a) through (i) until a predetermined condition is met.

The predetermined condition may be selected from the group comprising a predetermined amount of time having elapsed and a predetermined number of complete traversals of the pool floor.

The robot may further comprise an alignment-detection mechanism. The alignment-detection mechanism may comprise a compass (which may be a digital compass) and a rate gyroscope (which may be a Micro-Electro-Mechanical System rate gyroscope).

The controller may be further adapted to calculate the average compass reading over a predetermined period of time, compare the average to the gyroscope reading over the predetermined period, and compensate the reading of the rate gyroscope based on the comparison.

The robot may further comprise at least one tilt sensor, the controller being adapted to selectively determine, based on the reading of the at least one tilt sensor, the location of the robot based on the readings of the compass alone or based on the readings of the compass and the rate gyroscope.

The robot may further comprise a temperature sensor, the controller being adapted to compensate for reading of the rate gyroscope based on the reading of the temperature sensor.

Previous to step (a), the robot may orient itself such that its initial path is parallel to one sidewall of the pool.

In the specification and claims, the terms front detection, straight lap, and stepped lap are used as follows:
A front detection is a detection of a sidewall of the pool which intersects the trajectory of the robot, i.e., a sidewall in front of the robot which the robot impacts during scanning.
A straight lap comprises the robot scanning the pool in a straight path after one front detection, aligned so that its orientation is perpendicular to the detected sidewall, until another front detection occurs.
A stepped lap comprises the robot scanning the pool after one front detection, aligned so that its orientation is perpendicular to the detected sidewall, keeping the new orientation for a certain period of time which is not sufficient for the robot to completely traverse the bottom of the pool, and then rotating through approximately 90°.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIG. 1A is a perspective view of a pool cleaning system according to one embodiment of the present invention;

FIG. 1B is a closeup view of a user interface of the cleaning system illustrated in FIG. 1A;

FIG. 2 is a block diagram illustrating components of a control system of the pool cleaning system illustrated in FIG. 1;

FIG. 3 schematically illustrates part of an automated setup procedure of the pool cleaning system illustrated in FIG. 1;

FIGS. 4A through 4D schematically illustrate a scanning method, according to an embodiment of the present invention, which the pool cleaning system may be operated to follow according to a scanning algorithm; and

FIG. 5 schematically illustrates how a pool cleaning robot of the pool cleaning system illustrated in FIG. 1, may reverse direction and shift its trajectory upon detecting a sidewall.

### DETAILED DESCRIPTION OF EMBODIMENTS

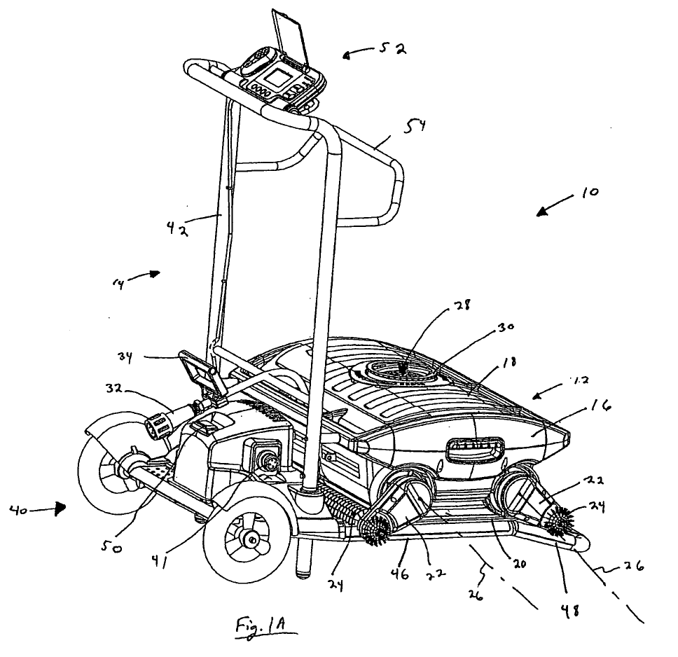

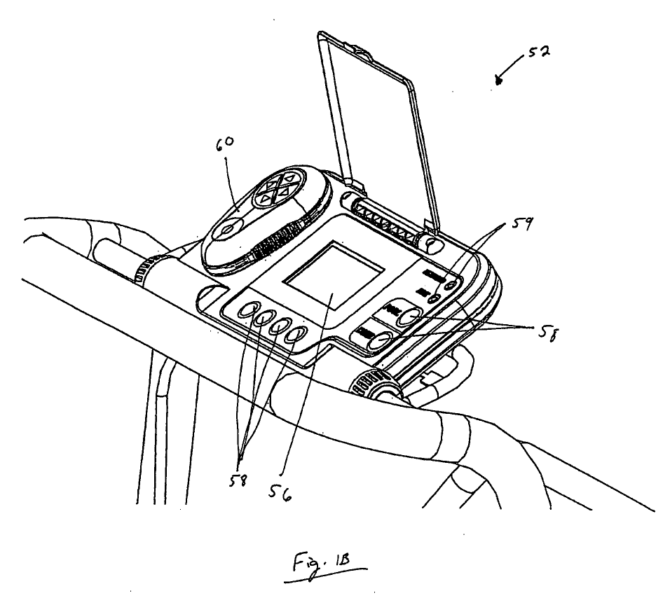

As illustrated in FIG. 1A, there is provided one example of a pool cleaning system, according to the present invention, which is generally indicated at 10. The pool cleaning system 10 comprises a pool cleaning robot 12 and a caddy 14.

The robot 12 comprises a main housing 16, a removable cover 18, which provides access to the interior of the main housing from the top of the robot, an internal motor unit (not seen) mounted within the main housing, a drive belt 20 driven by the motor unit, and two pairs of pivotable arms 22, each pair supporting an active brush 24 (only one pivotable arm 22 of each of the pairs is visible in FIG. 1A). Each pair of pivotable arms 22 and its respective brush 24 is adapted to pivot about an axis 26. The bottom of the robot 12 comprises one or more inlets (not seen), and the cover 18 comprises an outlet 28. One or more filters (not seen), which may be disposable, are provided within the main housing 16, in the fluid path between the inlet(s) and the outlet 28. The internal motor unit may also serve as, or include, a pump or impeller for pulling water through the inlet and expelling it through the outlet. Alternatively, a separate pump/impeller may be provided. An outlet cover 30 is provided, which serves not only to cover the outlet 28, but also as a twist-lock for the cover 18. In addition, an electrical cable 32, which is adapted, inter alia, to deliver power to the robot, and a pull-handle 34 are provided.

The robot 12 may be adapted for heavy duty use and cleaning large, such as Olympic or half-Olympic sized pools. Therefore, it is made of a sturdy material, such as Acrylonitrile Styrene Acrylate (ASA), and may be larger than other robots which are intended for cleaning smaller, e.g., residential, pools.

The caddy 14 comprises a base 40 and a U-shaped push-bar 42 attached thereto. A pair of wheels 44 is rotationally articulated to the base 40 at its end which is adjacent the push-bar 42. The base 40 comprises a socket 41 for connecting the electrical cable 32 thereto, and comprises a platform 46 sized for holding the robot 12 thereupon and forming a ramp 48 at one end, to permit the robot to easily mount and dismount the platform 46. The base is further provided with an on/off switch 50. The push-bar 42 is provided with a user interface 52 and a support rack 54 for storage thereupon of the electrical cable 32.

As illustrated in FIG. 1B, the user interface 52 comprises a display screen 56, touch-buttons 58, indicator lights 59, and a remote control 60. A cover may be provided to shield at least a part of the user interface, e.g., the screen 56 and touch-buttons 58, when not in use.

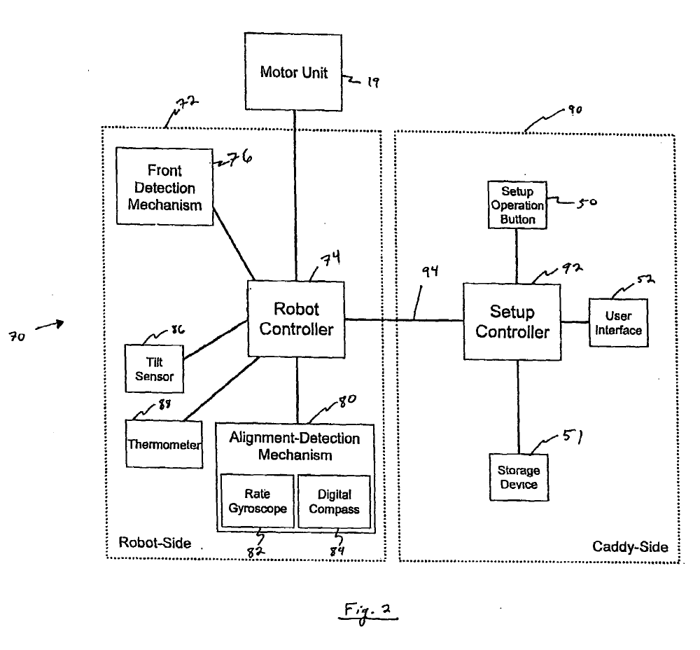

As schematically illustrated in FIG. 2, the pool cleaning system 10 comprises a control system, which is generally indicated at 70, whose components are located in both the robot 12 and the caddy 14. The control system is adapted, inter alia, to direct the operation of the robot and to gather setup and operation parameters therefor. Solid lines in FIG. 2 indicate operational connections between different elements, and the dotted rectangles delineate the “sides” of the control system, as described below.

The robot-side portion 72 of the control system 70, i.e., the group of elements of the control system which are physically located within the robot 12,, comprises a robot controller 74, a front detection mechanism 76, and an alignment-detection mechanism 80. The robot controller is adapted, inter alia, to direct the operation of the motor unit designated as 19, based partially on the input from the other elements of the robot-side portion 72 of the control system 70. It will be appreciated that while the motor unit 19 is indicated in FIG. 2 as being logically separate from the robot-side portion 72 of the control system 70, it may be located in physical proximity thereto. For example, the robot-side portion 72 of the control system 70 may be physically located within the motor unit 19.

The alignment-detection mechanism 80 is adapted to ensure that the robot's path remains straight when required. For this purpose, it comprises two instruments: a rate gyroscope 82, which may be, for example, a Micro-Electro-Mechanical System (MEMS) rate gyroscope, and a digital compass 84.

The rate gyroscope 82 is adapted to measure the rate of turn thereof. In addition, the speed and length of time of turn can be determined therefrom. The digital compass 84 is adapted to measure its absolute orientation with respect to magnetic north, and output a digital signal indicative thereof.

In addition, one or more tilt sensors 86 and a thermometer 88, which can be any appropriate temperature sensing device such a thermocouple, are provided. One or more of the tilt sensors 86 may be formed as a separate element from the robot controller 74 and operationally connected thereto; alternatively, it may be formed as a physical part of the robot controller.

The rate gyroscope 82 and the digital compass 84 are configured such that each of them performs particular functions toward this end. These functions are selected based on each instrument's particular set of limitations, such that each limitation of one of the instruments is complemented by a feature of the other instrument which does not suffer from this particular limitation, as will be explained below.

For example, the digital compass, which ideally would be appropriate for controlling the direction of the robot, suffers from the limitation that, due to its method of operation, is sensitive to magnetic interferences. Therefore, the digital compass would not properly control the direction of the robot, e.g., near a large metal surface, such as a wall fabricated from steel. Therefore, the rate gyroscope is used for this purpose, since it is not sensitive to magnetic interference. However, the rate gyroscope, while not sensitive to magnetic interference, may exhibit small “drift” errors. While a single error may not necessarily render the rate gyroscope measurement useless within a margin of error which would be acceptable for operation of the robot, any subsequent errors will accumulate, leading to an accumulated error which is beyond the acceptable margin of error. Therefore, the digital compass is used to mitigate the accumulation of the rate gyroscope errors, taking advantage of the fact that any magnetic interferences which affect the digital compass are short-lived. Therefore, once per predetermined time period, e.g., twenty or sixty seconds, the average compass reading during the time period is calculated. The result of this calculation compared to the rate gyroscope reading during this period, and any errors are corrected.

In addition, the use of the rate gyroscope itself may introduce other errors, which may be mitigated by using the digital compass. For example, the readings of the rate gyroscope on a surface which is not substantially flat are not accurate. However, the readings of the digital compass may be unaffected by the robot's tilting up to 45°. Therefore, the robot controller 74 may determine, based on the reading of the one or more tilt sensors 86, that the direction of the robot should be controlled solely using the measurements provided by the digital compass, until the tilt of the robot returns to a substantially horizontal position, at which point the direction of the robot is controlled as described above.

A further example of an error which may be introduced by using the rate gyroscope is due to the inherent sensitivity of the rate gyroscope to temperature. It will be appreciated that the operating temperature of the rate gyroscope affects it in a known way. Therefore, the robot controller 74 may, based on the reading of the thermometer 88, to compensate the reading of the rate gyroscope based on the temperature.

By using the combination of the rate gyroscope 82 and the digital compass 84, as described above, the robot controller 74 can ensure that the robot 12 follows a straight path when necessary. This functionality is supported by the inputs of the one or more tilt sensors 86 and thermometer 88, also as described above.

The caddy-side portion 90 of the control system 70, i.e., the group of elements of the control system which are physically located within the caddy 14, comprises a setup controller 92, the user interface 52, the on/off switch 50, and a digital storage device 51. The digital storage device may be an onboard memory module, such as a flash device or a hard drive, or it may be a port for a removable memory device, such as a floppy disk drive, a USB port, e.g., for receiving therein a disk-on-key, or a slot for a memory card. It will be appreciated that while the controller within the caddy-side portion of the control system is referred to as a “setup controller,” it may perform other functions which are not related to setup.

The setup controller 92 may comprise a receiver for accepting commands from the remote control 60. It may be located in any component of the caddy 14, e.g., such adjacent an upper portion of the U-shaped push-bar 42. It will be appreciated that some of the elements, while indicated in FIG. 2 as being separate from one another and only operationally connected with other elements, may be formed integrally with one another. The robot controller 74 and the setup controller 92 are operationally connected by a communications cable 94, which may be coupled with the electrical cable 32. Alternatively, a wireless connection may be used.

The setup controller 92 is adapted to provide a simple initial setup procedure to collect setup parameters, without requiring a specially trained technician to perform this task. The setup controller 92 is adapted, via the user interface 52, to prompt a user, in a challenge/response format, to input information concerning at least some setup parameters, based upon which the robot controller 74 directs operation of the robot during a scanning cycle. For example, a message presented on the display screen 56 may prompt the user to enter a parameter. The user would then respond via the touch-buttons 58, with the parameter. The parameter may be a geometric parameter, such as width or length of the pool, or a cycle parameter, such as the cycle time or the delay until cycle start.

As the robot 12 is designed to be able to maintain a straight path, several setup procedures may be automated. For example, in a rectangular pool, setup parameters, such as the directions along which the length and width extend, hereinafter the length direction and the width direction, respectively, may be automatically provided to the control system 70, for example during a one-time setup operation. Based on these directions, the control system may direct the robot 12 during normal operation to alter its course so that its trajectory remains along the length or width direction, as appropriate.

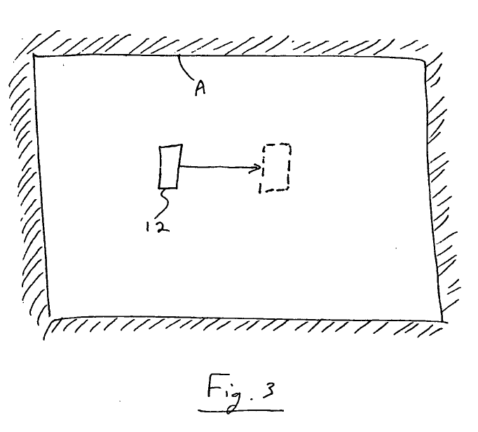

Therefore, the robot 12 may perform a setup operation in order to determine the length and width directions. With reference to FIG. 3, in which the solid rectangle represents the initial position of the robot, the dotted rectangle represents the final position of the robot, and the arrow represents the movement of the robot, the setup operation may be performed as follows: the robot 12 is placed in the pool, such that it's path is parallel to a sidewall A thereof. The remote control 60 may be used to align the robot. Subsequently, it scans for a predetermined period of time, e.g., twenty five seconds, in a straight path. During the scan, the compass reading is sampled at predetermined intervals, e.g., 0.1 seconds. At the end of the scan, the average compass reading is calculated and stored as the latitude direction of the pool, and the perpendicular direction is calculated and stored as the longitude direction.

The robot controller 74 may be preprogrammed to perform scanning according to one of several algorithms, for example which take advantage of the fact that the alignment-detection mechanism 80 is adapted to ensure that the robot 12 scans along a straight path.

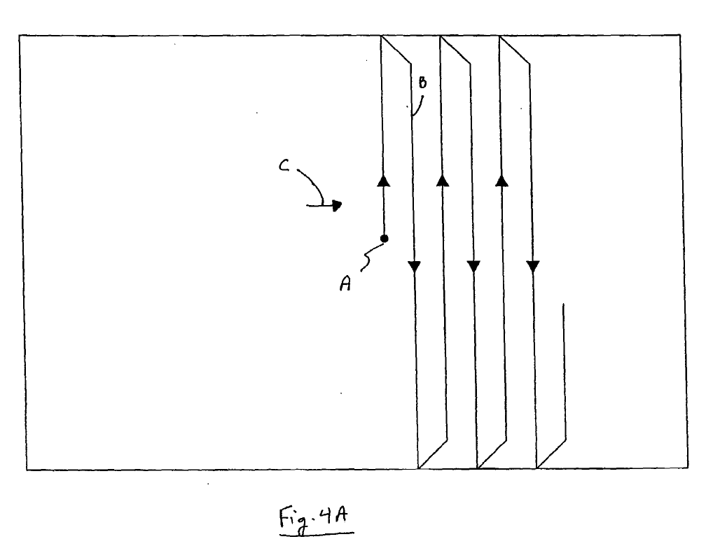

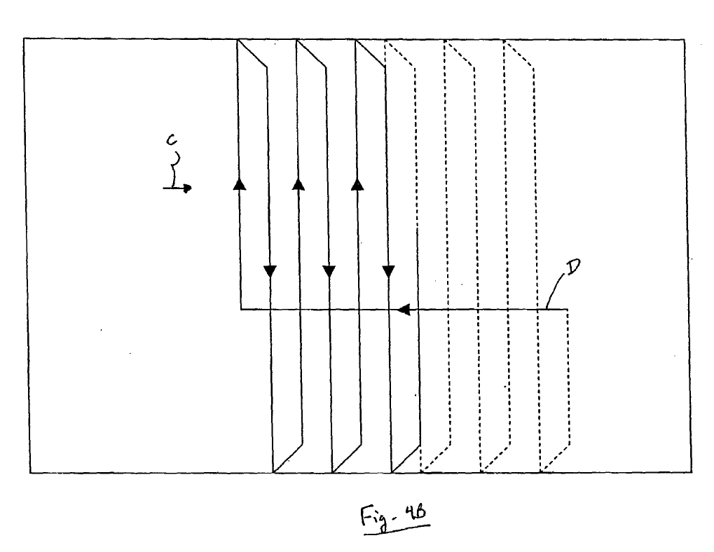

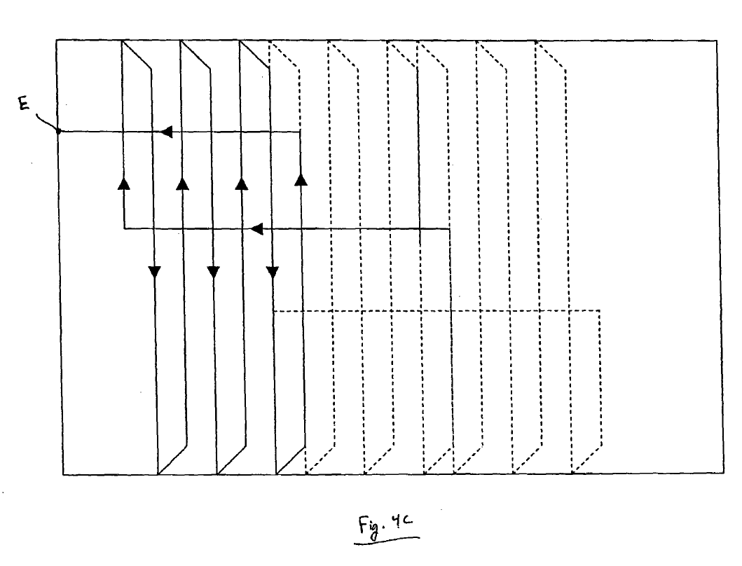

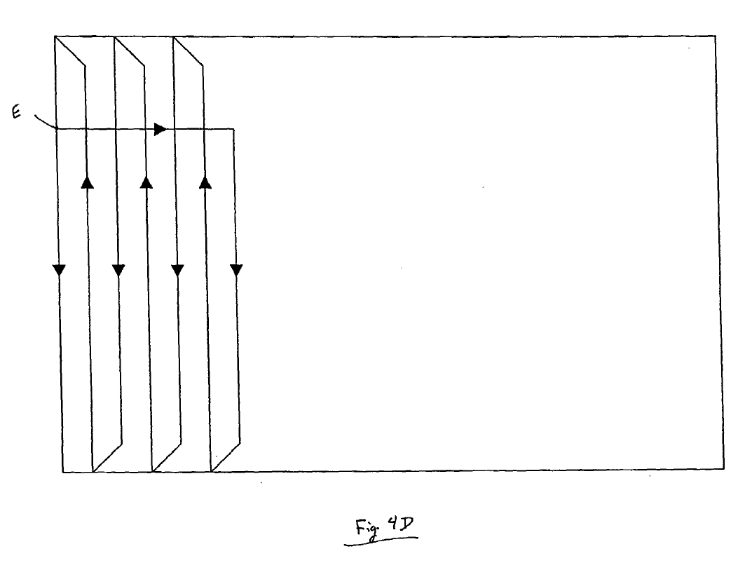

One example of such algorithm is illustrated in FIGS. 4A through 4D, where the algorithm involves the robot performing either stepped laps or straight laps between front wall detections in a substantially rectangular pool. As illustrated in FIG. 4A, the robot is placed in the pool at an arbitrary location, such as that indicated at A. The robot controller 74 first orients the robot so that its trajectory is parallel to one of the sidewalls of the pool, based on information gathered during setup, such as described above with reference to FIG. 3; then the controller operates the robot to scan until a front detection occurs (the latter being illustrated in FIG. 4A). After the front detection, the robot reverses direction and, until a subsequent front detection occurs, performs a straight lap along a path, indicated at B, which is shifted in a first shifting direction from the previous path. The distance between adjacent paths may be up to the width of the robot, so that no area of the pool floor remains un-scanned. The first shifting direction is indicated by arrow C. The first shifting direction is one which is perpendicular to the direction of scanning along of the previous path. This is repeated for a predetermined number, e.g., five, of straight laps, as illustrated in FIG. 4A. The predetermined number of straight laps constitutes a lap-cluster. It will be appreciated that as the distance of shifting is known, the width of the lap-cluster is also known. After the lap-cluster is complete (i.e., after the predetermined number of straight laps has been performed), the robot performs a stepped lap.

As illustrated in FIGS. 4B and 4C, after the 90° rotation of the stepped lap, the robot scans along a path indicated by D in a direction which is opposite that indicated by arrow C, so that is traverses the area scanned by the previous lap-cluster (the previous lap clusters being indicated in dashed lines in FIGS. 4B and 4C) plus distance equal to the width of an additional lap cluster (so that the length of the scan immediately following the stepped lap is the width of two lap clusters). The robot then performs another lap-cluster in a direction indicated by arrow C.

It will be appreciated that the length of the stepped lap may vary, even during a single cleaning cycle.

Scanning as described above with reference to FIGS. 4A through 4C continues until a front detection occurs as indicated in FIG. 4C at E, typically while scanning after the stepped lap immediately subsequent to a lap-cluster. As illustrated in FIG. 4D, subsequent to the front detection which occurred at E, the robot reverses direction and scans away from the detected sidewall for a distance which is equal to the length of one lap cluster.

The robot then begins scanning along the entire length of the pool. The first lap cluster is performed toward the just-detected wall; as the first straight lap of this one lap-cluster was located as a distance from the wall which is equal to the length of one lap-cluster, the final straight lap thereof is adjacent the sidewall. (It will be appreciated that the final lap-cluster is performed in a direction which is opposite those of the previous lap clusters.) Thus, the sidewall is cleaned, without the need of a mechanism which can detect a sidewall. Subsequently, the robot performs a stepped lap along the sidewall, and repeats the above (i.e., the steps described with reference to FIGS. 4A through 4C) until the opposite sidewall is detected.

When the opposite sidewall is detected, the robot reverses direction and scans away from the detected sidewall for a distance which is equal to the length of one lap cluster. The robot then performs a final lap-cluster. As above, the final straight lap of the lap-cluster is adjacent the sidewall.

Subsequently, the robot scans for part of the distance of the sidewall, rotates 90°, and begins scanning away from the sidewall. This scanning constitutes the beginning of a new lap-cluster which is oriented at 90° to all of the previous lap clusters. The process described above is then repeated by the robot.

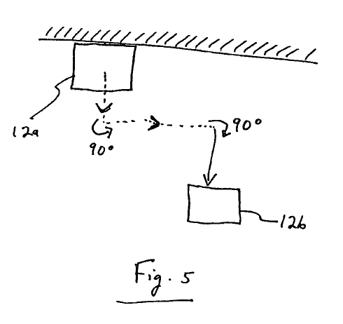

As illustrated in FIG. 5, the robot may perform reversing and shifting (e.g., after a front detection) as follows: after a front detection, the robot, indicated at its initial position at 12a retreats from the sidewall for a first predetermined amount of time, e.g., one second. Then, it rotates 90° in a first direction, and scans for a second predetermined amount of time, e.g., two seconds. The second predetermined amount of time may be selected such that the robot will traverse a distance not exceeding its own width. Subsequently, the robot rotates 90° in an opposite direction, and begins the next lap (the final position of the robot being indicated at 12b).

Those skilled in the art to which this invention pertains will readily appreciate that numerous changes, variations and modifications can be made without departing from the scope of the invention mutatis mutandis.

1. A pool cleaning robot adapted to move in a direction along the bottom surface of a pool, said robot comprising a compass, a rate gyroscope, and a controller adapted to determine the orientation of the robot, relative to a reference orientation thereof, based on readings of the compass and the gyroscope.

2. A pool cleaning robot according to claim 1, wherein said rate gyroscope is a Micro-Electro-Mechanical System rate gyroscope.

3. A pool cleaning robot according to claim 1, wherein said compass is a digital compass.

4. A pool cleaning robot according to claim 1, wherein said controller is adapted to calculate the average compass reading over a predetermined period of time, compare said average to the gyroscope reading over said predetermined period, and compensate the reading of the rate gyroscope based on the comparison.

5. A pool cleaning robot according to claim 1, further comprising at least one tilt sensor, said controller being adapted to selectively determine, based on the reading of the at least one tilt sensor, the location of the robot based on the readings of the compass alone or based on the readings of the compass and the rate gyroscope.

6. A pool cleaning robot according to claim 1, further comprising a temperature sensor, said controller being adapted to compensate for reading of the rate gyroscope based on the reading of the temperature sensor.

7. A pool cleaning robot according to claim 1, said pool being rectangular, the reference orientation being one of the length and width of the pool.

8. A method of determining the orientation of a pool cleaning robot relative to a reference location, said robot comprising a compass, a rate gyroscope, and a controller adapted to determine said orientation, the method comprising determining said orientation based on readings of the compass and the gyroscope.

9. A method according to claim 8, wherein said rate gyroscope is a Micro-Electro-Mechanical System rate gyroscope.

10. A method according to claim 8, wherein said compass is a digital compass.

11. A method according to claim 8, wherein said controller is adapted to calculate the average compass reading over a predetermined period of time, compare said average to the gyroscope reading over said predetermined period, and compensate the reading of the rate gyroscope based on the comparison.

12. A method according to claim 8, said robot further comprising at least one tilt sensor, said controller being adapted to selectively determine, based on the reading of the at least one tilt sensor, the location of the robot based on the readings of the compass alone or based on the readings of the compass and the rate gyroscope.

13. A method according to claim 8, said robot further comprising a temperature sensor, said controller being adapted to compensate for reading of the rate gyroscope based on the reading of the temperature sensor.

14. A method according to claim 8, said pool being rectangular, the reference orientation being one of the length and width of the pool.

15. A setup system for a pool cleaning system, said pool cleaning system comprising a pool cleaning robot and a control system, said control system comprising a first controller adapted to direct the operation of the robot based on predetermined setup parameters, a second controller, and a user interface having at least one input/output mechanism; said second controller being adapted to:
(a) communicate with said first controller to provide said setup parameters thereto;
(b) issue commands to the first controller to direct the operation of the robot; and
(c) prompt a user, via said user interface, to perform an operation and/or to provide information, based on which at least some of the operational parameters are determined.

16. A setup system according to claim 15, wherein at least one of said setup parameters is selected from the group comprising one or more dimensions of the pool, cycle time, delay until cycle start, scanning method, whether to log scanning data, and pool shape.

17. A setup system according to claim 15, wherein said control system is adapted to store multiple sets of setup parameters for multiple pools.

18. A setup system according to claim 15, wherein said control system is adapted to store scanning data.

19. A setup system according to claim 18, wherein said control system is adapted to store said scanning information on removable media.

20. A setup system according to claim 15, wherein said user interface further comprises a remote control adapted to communicate with said first controller to provide instructions regarding directing the robot.

21. A setup system according to claim 20, wherein said instructions relate to the orientation of the robot.

22. A setup system according to claim 15, wherein said user interface is adapted to display information regarding the status the robot.

23. A setup system according to claim 22, wherein said information relates to one or more of filter status, alert status, pool information, and cycle status.

24. A setup system for a pool cleaning robot adapted to move in a direction along the bottom surface of a substantially rectangular pool, said robot comprising a controller, adapted to direct the operation of the robot, and digital compass in communication with said controller said controller being adapted to direct the operation of the robot based on geometric parameters of the pool, said setup system being adapted to communicate with said controller to direct the robot to perform the following operations to determine at least some of said parameters:
(a) aligning the robot such that its direction of travel is perpendicular to a sidewall of the pool;
(b) scanning along a straight trajectory for a first predetermined time; and
(c) calculating the average trajectory of the robot measured by the digital compass over the first predetermined time; and
(d) determining at least some of said parameters based on the average trajectory.

25. A setup system according to claim 24, wherein said setup system is further adapted to receive user input based on which the controller performs the alignment.

26. A method for cleaning a bottom surface of a pool, said method comprising the steps of providing a pool cleaning robot comprising a controller adapted to direct its operation, said controller directing operation of the robot such that:
(a) the robot scans in a first scanning direction until a front detection occurs;
(b) after the front detection, the robot reverses direction and performs a straight lap along a path which is shifted, in a first shifting direction perpendicular to that of the first scanning direction, from the previous path;
(c) the robot repeats step (b) for a predetermined number of times;
(d) subsequently, the robot performs a stepped lap, and after the 90° rotation thereof, scans in a second shifting direction which is opposite the first shifting direction for a distance equal to twice the total amount shifted during step (c);
(e) subsequently, the robot rotates 90°, and scans until a front detection occurs;
(f) steps (b) through (d) are repeated until a front detection occurs during step (d);
(g) subsequently, the robot reverses direction and scans for a distance equal to the total amount shifted during one iteration of step (c), then rotates 90° and scans until a front detection occurs; and
(h) subsequently, the robot repeats steps (b) through (f), with the directions of the first and second shifting directions being reversed.

27. A method according to claim 26, wherein said controller further directs operation of the robot such that:
(i) subsequently, the robot performs a stepped lap, and performs a straight lap; and
(j) the robot repeats steps (a) through (i) until a predetermined condition is met.

28. A method according to claim 27, wherein the predetermined condition is selected from the group comprising a predetermined amount of time having elapsed and a predetermined number of complete traversals of the pool floor.

29. A method according to claim 26, said robot further comprising an alignment-detection mechanism.

30. A method according to claim 29, wherein said alignment-detection mechanism comprises a compass and a rate gyroscope.

31. A method according to claim 30, wherein said rate gyroscope is a Micro-Electro-Mechanical System rate gyroscope.

32. A method according to claim 30, wherein said compass is a digital compass.

33. A method according to claim 30, said controller being further adapted to calculate the average compass reading over a predetermined period of time, compare said average to the gyroscope reading over said predetermined period, and compensate the reading of the rate gyroscope based on the comparison.

34. A method according to claim 30, said robot further comprising at least one tilt sensor, said controller being adapted, based on the reading of the at least one tilt sensor, to selectively determine the location of the robot based on the readings of the compass alone or based on the readings of the compass and the rate gyroscope.

35. A method according to claim 30, said robot further comprising a temperature sensor, said controller being adapted to compensate for reading of the rate gyroscope based on the reading of the temperature sensor.

36. A method according to claim 26, wherein previous to step (a), the robot orients itself such that its initial path is parallel to one sidewall of the pool.
